(19) United States
(12) Patent Application Publication
(10) Pub. No.: US 2005/0155816 A1
(43) Pub. Date: Jul. 21, 2005

(54) Dynamic exhaust system for advanced internal combustion engines

(76) Inventors: William V. Alcini, Ypsilanti, MI (US); Pavel Robles, Jackson, MI (US); Richard Veneziano, Jackson, MI (US); Rico Weinert, Gommersheim (DE); Alexander Schinko, Mannheim (DE); George Labarge, Tecumseh, MI (US)

Correspondence Address: HARNESS, DICKEY & PIERCE, P.L.C., P.O. BOX 828, BLOOMFIELD HILLS, MI, 48303, US

(21) Appl. No.: 10/760,179

(22) Filed: Jan. 16, 2004

(51) Int. Cl. F01N 1/00; F16K 17/00

(52) U.S. Cl. 181/237; 181/236

(57) ABSTRACT

A dynamic exhaust system is capable of operating at high temperatures and provides a passive, temperature resistant valve for controlling reflection, restriction and/or rerouting of the exhaust gas flow for sound control and/or emissions control in advanced internal combustion engines, such as cylinder deactivation, variable displacement, hybrid power plant, and cold hydrocarbon traps.

### BACKGROUND OF THE INVENTION

The invention relates generally to sound, performance and emission control in vehicles utilizing advanced technology, such as cylinder deactivation or hybrid power sources wherein discontinuations occur in the exhaust gas flow rate during operation of the engine.

Conventional internal combustion engines or power sources continuously use all cylinders during operation. Advanced internal combustion engine systems include non-conventional internal combustion power plants, such as cylinder deactivation engines, and are more difficult to acoustically attenuate in the exhaust system, because they have a broader range of noise frequencies and a broader range of gas flow (volume per unit time) to deal with. The use of a muffler valve to achieve greater acoustic attenuation is known, especially with conventional engine systems. Passive valves are traditionally used only on conventional engines at lower temperature locations in the exhaust system downstream of the engine. Recently, expensive systems to achieve noise attenuation in advanced non-conventional engine vehicles have utilized active or semi-active valves to handle variable exhaust flow requirements and to simultaneously withstand increased heat requirements of such advanced engine systems. Such active or semi-active valves, however, involve not only expensive hardware and accessory power systems to actuate such valves, but additionally are associated with expensive control modules with accompanying software control for vehicles incorporating such advanced engine techniques. These more expensive active or semi-active valve systems have recently been used due to the inability of previous passive muffler valve arrangements to withstand the heat requirements in areas along a longitudinal length of the exhaust system where the use of such valves is most optimally applied to noise abatement, performance improvement and/or emission reduction.

Passive valves have traditionally been used to create dynamic exhaust systems in conventional engines. However, these systems have a continuous response proportional to engine speed, a continuous increase in exhaust system pressure as a function of engine speed, and do not have to deal with conditions that are not continuous with engine speed but rather involve step functions of exhaust flow during operation of the vehicle's power source. Many advanced engine designs, such as cylinder deactivation systems, create unique exhaust conditions that are not continuous with engine speed or possess larger than normal ranges in exhaust flow wherein cost effective management of sound and/or emissions cannot be met by conventional exhaust system designs.

For the purposes of this disclosure, a “passive valve” is one in which the motive force to operate the valve comes from the energy (velocity or pressure) in exhaust gas flow. For the case of a gas velocity powered valve, the motive energy comes from the velocity of the gas hitting a component of the valve, such as a head or flapper or other element placed in the exhaust stream. For the case of pressure, the valve is moved by forces exerted from a pressure difference between an upstream and a downstream location on either side of the valve element. In summary, the valve is controlled and moved by conditions on either side of the valve element which has been placed in the exhaust stream.

A “semi-active valve” in addition to utilizing the motive forces for operation used by a passive valve, additionally utilizes motive force that does not burden the gas flow. This additional motive force is derived from an external pressure differential between the interior of the exhaust system and atmospheric pressure.

An “active valve” is powered or controlled at least in part by a source other than the exhaust pressure or gas velocity. For example, a vehicle engine controller may send an electrical signal to a solenoid-operated valve whenever appropriate conditions so dictate. The solenoid, in turn, controls a vacuum to an actuator for the valve which is appropriately positioned in the exhaust stream.

### SUMMARY OF THE INVENTION

In accordance with the need demonstrated by the prior art, a method of controlling exhaust flow in an exhaust system for a non-conventional internal combustion power source exhibiting, during operation, larger ranges of acoustic frequency, flow rate or pressure in exhaust flows than found in conventional internal combustion power sources places a passive, temperature resistant valve in a path of exhaust gas flow, the valve operative to at least partially alter a characteristic of the exhaust gas flow for the larger ranges.

In another aspect of the invention, an arrangement for controlling exhaust flow in an exhaust system for an internal combustion power source exhibiting, during operation, larger ranges of acoustic frequency, flow rate or pressure in exhaust flows than found in conventional internal combustion power sources includes a passive temperature resistant valve positioned in a path of exhaust gas flow, the valve operative to at least partially alter a characteristic of the exhaust gas flow for the larger ranges.

### BRIEF DESCRIPTION OF THE DRAWING

The objects and features of the invention will become apparent from a reading of a detailed description, taken in conjunction with the drawing, in which:

FIG. 1 is a top perspective view of an exhaust system for an advanced internal combustion engine arranged in accordance with the principles of the invention; and

FIG. 2 sets forth region 2 of FIG. 1 in more detail.

### DETAILED DESCRIPTION

The invention utilizes the application of a low cost passive valve which can withstand high temperatures allowing the design freedom to locate the valve in the exhaust system at a position where optimum sound attenuation results. This passive, temperature resistant valve is specifically applied to advanced non-conventional power sources which are more challenging to acoustic attenuation.

Advanced internal combustion power sources for vehicles significantly change their gas flow characteristics during operation. Examples of such advanced non-conventional engine technologies include cylinder deactivation systems, hybrid systems including gas/electric, hydrogen or other types of hybrid source powered vehicles. Use of the passive, temperature resistant valve in such exhaust systems restricts, reflects, and/or routes the exhaust gas stream for the purposes of improving emissions, performance or sound control, or combinations thereof.

It has been determined by experience that the most effective location for such a passive, temperature resistant valve in the exhaust stream of an advanced internal combustion engine powered vehicle is approximately at the longitudinal midpoint of the exhaust gas flow. It is believed that positioning of the valve at this location most effectively disturbs or breaks up low frequency, long length sound waves being propagated along the exhaust path. This is especially true in cylinder deactivation-type power plants where a portion of the internal combustion cylinders are deactivated under appropriate operating conditions, thereby generating a discontinuity in the gas flow of the exhaust. Other placements of the valve produce acceptable results when the valve is between an engine end of the exhaust system and a longitudinal midpoint thereof. Additionally, it may be acceptable to place the valve closer to the midpoint than to either end of the exhaust system.

It has additionally been determined that the most effective acoustic attenuation in such exhaust systems is obtained by placing a barrier surface in the gas stream having an approximately perpendicular surface with respect to an axial flow direction of the exhaust stream. Such a transverse barrier surface is believed to set up more effective reflections in the sound waves associated with the exhaust to provide better noise cancellation.

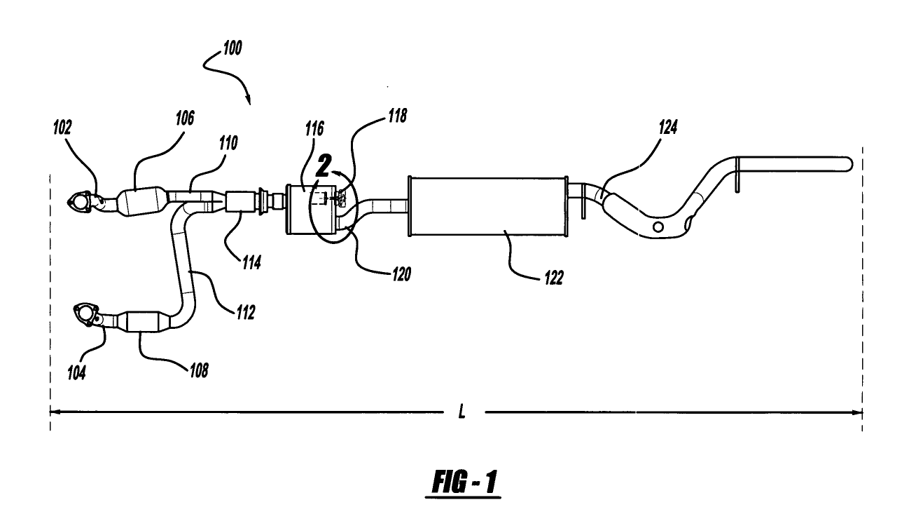

One example of the use of a passive, temperature resistive valve to control sound in an exhaust system of a cylinder deactivation engine-type vehicle is set forth in the perspective view of FIG. 1. With reference to FIG. 1, an exhaust system 100 for a cylinder deactivation engine system, such as a V-8 internal combustion engine having the capability of deactivating up to four of the eight cylinders at a time is set forth. System 100 includes manifold exhaust conduits 102 and 104, respectively, for first and second cylinder banks of the engine (not shown). Situated in conduits 102 and 104 are catalytic converters 106 and 108, respectively, which are, in turn, coupled via exhaust conduits 110 and 112 to a flexible joint and collector element 114.

Flexible joint 114 is coupled to an input of a resonator or mini-muffler 116. Interior to resonator 116 is at least a first conduit which has an outlet at least partially restricted via a passive, temperature resistant valve element 118. An outlet of resonator 116 is coupled to an intermediate exhaust conduit 120 which passes the exhaust stream to a muffler 122. An output of muffler 122 is, in turn, coupled to an exhaust system tailpipe 124. “L” represents a longitudinal length of exhaust system 100. As mentioned previously, it has been found that the positioning of the restricting valve 118 is optimally placed approximately in the midpoint along axial distance L, or between the midpoint and the engine, or at least nearer to the midpoint, or L/2 than to either endpoint of the exhaust system apparatus.

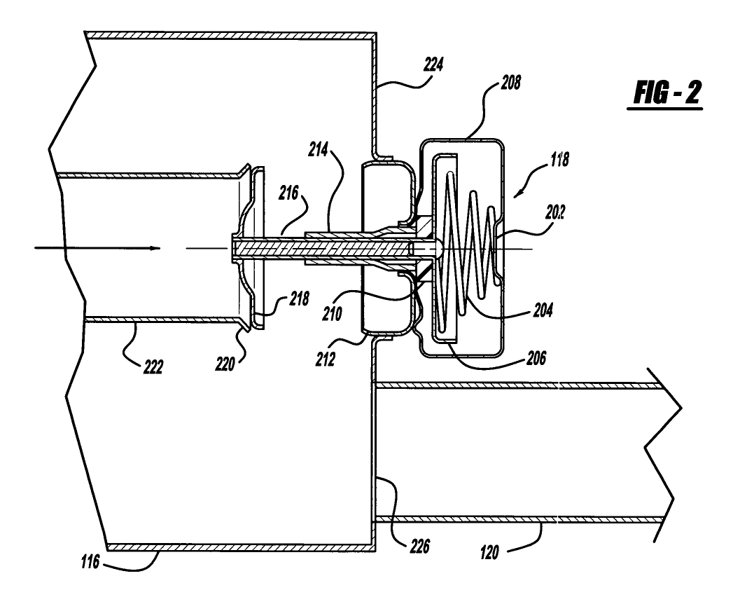

With reference to FIG. 2, details of a passive temperature resistive valve suitable for use with the invention and its location with respect to a resonator 116 of FIG. 1 are set forth. An end 220 of an exhaust conduit 222 extending into the resonator 116 from an inlet thereof is conically widened or flanged at end 220. Similarly, a peripheral edge of conical valve disk 218 is conically flared to the purpose of the curved or flared interface is to promote good gas flow characteristics. Valve disk 218 lies adjacent end 220 of conduit 222. Alternatively, an unflared or straight-edged conduit and mating disk 218 may be employed. While valve surface 218 is shown substantially closing off an outlet of conduit 222, it has been found optimum, in the rest position of valve 118 to maintain an opening annular gap between end 220 of conduit 222 and valve disk 218 of on the order of one to two millimeters for optimum noise attenuation.

Valve disk 218 is mounted on a guide rod 216, guided in turn in a guide sleeve 214. Guide sleeve 214 is held by an assembly sleeve 212 mounted in a gastight fashion to the wall of the housing of resonator 116. External to the resonator 116, a valve housing 208 holds a conical spring 204 which is retained by a spring suspension member 202. The other end of spring 204 bears upon a spring guide disk 206 mounted at the end of the guide rod 216. In this way, spring 204 has a secure support and distributes its force symmetrically and axially to guide rod 216.

Between the spring guide disk 206 and the valve housing 208, a ring 210 of wire net is placed on guide rod 216 to serve as a damping element to abate noise interference which could otherwise be caused by vibrations of valve disk 218.

When the quantity of exhaust gas flowing through conduit 222 into the housing of resonator 116 increases sufficiently—e.g., by activating all eight cylinders of the engine coupled to exhaust system 100, the impact on valve disk 218 is sufficient to force element 218 away from end 220 of conduit 222 against the force of spring 204 to substantially remove restriction of exhaust gas flow. When the exhaust gas flow discontinuously decreases during engine operation, for example, by deactivating four of the eight cylinders of the engine, the force of spring 204 overcomes the exhaust flow force exerted on member 218, allowing it to travel to the left as shown in FIG. 2 to substantially restrict the exhaust flow which sets up reflections of the sound waves accompanying the exhaust flow which tend to be of long length and low frequency under such engine operating conditions. This restriction/reflection effect thereby attenuates sound under the four cylinder engine operating condition without the need to resort to unacceptably large muffler volumes that would otherwise be required.

Other examples of the use of a passive, temperature resistant valve as described above, would include rerouting of exhaust gases under appropriate gas flow conditions to make more effective and dynamic use of conventional muffler systems or emission control systems.

Valve 118 as set forth in FIG. 2, is “temperature resistant”, in that its spring biasing component is housed exteriorly of the actual flow path of exhaust gases in the systems. Additionally, valve 118 contains no membrane elements conventionally required in active and semi-active valve components which are more susceptible to degradation under high temperature.

Finally, from FIG. 2, it will be seen that exhaust gas flow, whether restricted under low flow conditions or unrestricted under high flow conditions continues its path out of conduit 222 into the interior of resonator 116 and then through outlet opening 226 of resonator 116 into intermediate exhaust conduit 120.

Hence, the invention enables the restriction, reflection or rerouting of exhaust gases in power plants which significantly change their gas flow characteristics during operation for the purposes of improving emissions or control of sound in the exhaust system. Additionally, the passive valve, appropriately positioned within the exhaust system offers high temperature, e.g., above 700° C., resistance for periods of time which is required in many advanced internal combustion systems.

The invention has been described with reference to a detailed description of a preferred embodiment. The scope and spirit of the invention are to be determined from appropriate interpretation of the appended claims.

1. A method of controlling exhaust flow in an exhaust system for a non-conventional internal combustion power source exhibiting, during operation, larger ranges of acoustic frequency, flow rate or pressure in exhaust flow than found in conventional internal combustion power sources, the method comprising:
placing a passive temperature resistant valve in a path of exhaust gas flow, the valve operative to at least partially alter a characteristic of the exhaust gas flow for the larger ranges.

2. The method of claim 1 wherein the characteristic of the exhaust gas flow comprises at least one of flow restriction, flow reflection and flow direction.

3. The method of claim 1 wherein the passive, temperature resistant valve is placed nearer to a midpoint of the exhaust system than to an endpoint thereof.

4. The method of claim 1 wherein the passive, temperature resistant valve is placed substantially at a midpoint of the exhaust system.

5. The method of claim 1 wherein the passive, temperature resistant valve is placed between a midpoint of the exhaust system and the non-conventional power source.

6. A method of sound control in an exhaust system for an internal combustion power source exhibiting discontinuities in exhaust gas flow during operation, the method comprising:
placing a passive, temperature resistant valve in a path of exhaust gas flow, the valve operative to at least partially alter restriction of the exhaust gas flow whenever a discontinuity occurs.

7. The method of claim 6 wherein the passive, temperature resistant valve increases restriction of exhaust gas flow whenever a discontinuous decrease in exhaust gas flow rate occurs.

8. The method of claim 7 wherein the passive, temperature resistant valve restricts exhaust gas flow via a valve surface extending substantially perpendicular to a longitudinal axis of exhaust flow.

9. The method of claim 6 wherein the passive, temperature resistant valve is placed nearer to a midpoint of the exhaust system than to an endpoint thereof.

10. The method of claim 8 wherein the passive, temperature resistant valve is placed nearer to a midpoint of the exhaust system than to an endpoint thereof.

11. The method of claim 6 wherein the passive, temperature resistant valve is placed between a midpoint of the exhaust system and the internal combustion power source.

12. The method of claim 6 wherein the passive, temperature resistant valve is placed substantially at a midpoint of the exhaust system.

13. The method of claim 8 wherein the passive, temperature resistant valve is placed substantially at a midpoint of the exhaust system.

14. The method of claim 8 wherein the passive, temperature resistant valve is placed between a midpoint of the exhaust system and the internal combustion power source.

15. The method of claim 8 wherein the valve surface is positioned in a resonator having an inlet coupled to an interior conduit extending into the resonator and terminating in the resonator adjacent to the valve surface.

16. An arrangement for controlling exhaust flow in an exhaust system for a non-conventional internal combustion power source exhibiting, during operation, larger ranges of acoustic frequency, flow rate or pressure in exhaust flows than found in conventional internal combustion power sources the arrangement comprising:
a passive, temperature resistant valve positioned in a path of exhaust gas flow, the valve operative to at least partially alter a characteristic of the exhaust gas flow for the larger ranges.

17. The arrangement of claim 16 wherein the characteristic of the exhaust gas flow comprises at least one of flow restriction, flow reflection and flow direction.

18. The arrangement of claim 16 wherein the passive, temperature resistant valve is placed nearer to a midpoint of the exhaust system than to an endpoint thereof.

19. The arrangement of claim 16 wherein the passive, temperature resistant valve is placed substantially at a midpoint of the exhaust system.

20. The arrangement of claim 16 wherein the passive, temperature resistant valve is placed between a midpoint of the exhaust system and the internal combustion power source.

21. An arrangement for controlling sound in an exhaust system for an internal combustion power source exhibiting, during operation, discontinuity in exhaust gas flow, the arrangement comprising:
a passive, temperature resistant valve positioned in a path of the exhaust gas flow, the valve operative to at least partially alter restriction of the exhaust gas flow whenever a discontinuity occurs.

22. The arrangement of claim 21 wherein the passive, temperature resistant valve increases restriction of exhaust gas flow whenever a discontinuous predetermined decrease in exhaust gas flow rate occurs.

23. The arrangement of claim 22 wherein the passive, temperature resistant valve restricts exhaust gas flow via a valve surface extending substantially perpendicular to a longitudinal axis of exhaust flow.

24. The arrangement of claim 23 wherein the valve surface is positioned in a resonator having an inlet coupled to an interior conduit extending into the resonator and terminating in the resonator adjacent to the valve surface.
